(19) United States
(12) Patent Application Publication
(10) Pub. No.: US 2013/0303319 A1
(43) Pub. Date: Nov. 14, 2013

(54) TRACTION-MECHANISM DRIVE HAVING A TENSIONER AND A CLAMPING ELEMENT

(71) Applicants: Markus Fischer, Hessdorf (DE); Christian Hartmann, Nemsdorf (DE); Friedrich Ness, Dachsbach (DE)

(72) Inventors: Markus Fischer, Hessdorf (DE); Christian Hartmann, Nemsdorf (DE); Friedrich Ness, Dachsbach (DE)

(73) Assignee: Schaeffler Technologies AG & Co.,, Herzogenaurach (DE)

(21) Appl. No.: 13/981,455

(22) PCT Filed: Oct. 28, 2011
(86) PCT No.: PCT/EP11/68956

§ 371 Date: Jul. 24, 2013

(30) Foreign Application Priority Data
Jan. 24, 2011 (DE) 10 2011 003 056.5

(51) Int. Cl. F16H 7/10

(52) U.S. Cl. CPC F16H 7/10
USPC 474/110

(57) ABSTRACT

A traction mechanism drive having a hydraulic tensioner (1) which has a housing (2) fabricated from a light-metal alloy in which a slide sleeve (4) manufactured of steel is inserted that has an axially extendable piston for deflecting a tensioning and guide unit, such as a roller or a rail, a securing element (11) being clampingly disposed between the housing and the slide sleeve to prevent the slide sleeve (4) from moving out of the housing (2). Also, an internal combustion engine having such a traction-means drive and a tensionable traction means.

The present invention relates to a traction-means drive having a hydraulic tensioner, which has a housing fabricated from a light-metal alloy in which a slide sleeve manufactured of steel is inserted that has an axially extendable piston for deflecting a tensioning and guide unit, such as a roller or a rail.

### BACKGROUND

Traction-means or mechanism drives are used for internal combustion engines and include what are generally referred to as traction-means tensioners, which, inter alia, can be of a mechanical, hydraulic, automatic or semi-automatic type.

As traction means, such traction-means drives typically employ either belts, such as toothed belts, or chains, such as timing chains. Such traction-means drives are used, in particular, for timing drives of internal combustion engines. Additionally or alternatively, they can also drive other aggregates, such as generators, electric generators, air-conditioning units or electric machines.

The traction means are unfortunately subject to an elongation that must be compensated. Temperature-dependent stresses and strains in the traction means must also be compensated.

The traction-means tensioners are typically used for this purpose. Hydraulic tensioners are often used to make an automatic retensioning possible. The technical literature also refers to such traction-means tensioners as belt tensioners in connection with the use of belts, and also as chain tensioners in connection with the use of chains.

Such traction-means drives having a hydraulic tensioner often have housings that are fabricated of light metal, such as aluminum housings, into which a separate slide sleeve made of a ferrous material, such as steel, is inserted. An extendable piston, which is able to press on a tensioning and guide unit, such as a roller or a rail, is then provided in the slide sleeve in order to deflect this roller or rail and, in the process, tension the traction means, such as the belt or the chain. In this context, the traction means passes over the tensioning and guide unit. Arresting systems are often used as well in order to prevent the piston from retracting again or to only allow it to a limited extent.

Tensioners are known, for example, from the German Patent Application DE 10 2008 005 765 A1 and the U.S. Patent Application 2010/0062886 A1. However, U.S. Patent Application 2010/0062886 A1 focuses merely on using a stopper ring to block the piston from retracting again.

A securing means for securing a connecting element is known from another technical field, namely that of securing means for screws. In this context, a screw is secured by a lug, as described in the German Patent Application DE 10 2009 009 365 A1.

### SUMMARY OF THE INVENTION

In the case of traction-means drives having hydraulic tensioners, however, it is necessary to ensure, on the one hand, that the piston is able to travel out of the steel slide sleeve, and, on the other hand, that the slide sleeve is seated in an axially fixed and, to the greatest degree possible, also in a radially fixed manner in the housing that is manufactured of the light-metal alloy. However, at different temperatures and loads, it turns out that, under certain circumstances, the slide sleeve moves axially out of the housing. This is especially the case when the housing is fabricated of an aluminum alloy. Generally, therefore, efforts directed to preventing the slide sleeve from being lifted out of the aluminum housing are readily apparent in the related art.

Customary approaches, such as securing by interlocking deformation and press-fitting are not recommended since die-cast aluminum housings are frequently used, and die-cast aluminum is very brittle due, in particular, to the casting skin. Also, it has poor plastic deformation properties. The use of polygon rings is also disadvantageous and should be avoided.

However, to ensure that the slide sleeve is not lifted out of the aluminum housing even at a high oil pressure, which would then result in a negative dynamic behavior of a traction-means drive and thereby in excessive forces in the individual components, it is necessary to find an especially cost-effective and, at the same time, efficient approach.

The present invention provides a securing element that is clampingly disposed between the housing and the slide sleeve to prevent the slide sleeve from moving out of the housing.

Upon installation of the tensioner, respectively of the traction-means drive in the housing, the securing element then grips the cylindrical surface area thereof and the cylindrical lateral surface of the slide sleeve. Thus, the slide sleeve of the tensioner is no longer able to lift off from the housing bottom. The slide sleeve is then securely fastened in the housing.

A particular advantage is derived in that there is no need to alter the mass-produced components of the housing, and the installation of the individual elements is not made more difficult. In addition, the supplying of the piston with a hydraulic medium, such as oil, is not limited.

Advantageous specific embodiments are set forth in the dependent claims and are clarified in greater detail in the following.

Thus, it is advantageous for the securing element to be designed as a sheet-metal part or as a spring-wire part. This additional component is used, in particular, for chain tensioners characterized by a low spring force and having arresting systems, since they tend to lift off at pressure peaks in the oil supply, in particular in response to high dynamic stress. As explained, such a lifting off may lead to mechanical damage, however, and, to some extent, to considerable wear of the aluminum housing bottom. A securing against the lifting off is efficiently ensured by the sheet-metal component or the spring-wire component.

When the spring-wire component has a polygon shape and/or a wave shape, a variant may be achieved that is simple to install.

Another exemplary embodiment is characterized in that the securing element at least partially or even completely embraces the periphery of the slide sleeve. In this variant, the securing element may be readily slid onto the housing-side end of the slide sleeve, and this combination may be subsequently inserted into the aluminum housing. This installation operation may be implemented relatively simply and reliably in terms of process.

To facilitate installation and ensure a good force characteristic, it is advantageous that the component be configured in a closed bottom region of the housing, which, in addition, is preferably adjacent to a pressure chamber in the interior of the slide sleeve.

It proves to be particularly advantageous for the sheet-metal part to be shaped into a conical form and inserted between the aluminum housing and the steel housing of the slide sleeve.

The sheet-metal part has one or a plurality of tabs on the inner rim, at least one tab resting against the slide sleeve essentially facing in an extended direction of the piston, and at least one portion of the inner rim of the sheet-metal part that is free of tabs, that rests against the slide sleeve, essentially facing counter to the extended direction of the piston. In this context, oblique configurations are understood to be those configurations which extend transversely to a longitudinal axis of symmetry of the piston.

It is possible that the sheet-metal part is initially oriented essentially transversely to the longitudinal axis, however, in the end state, thus in the clampingly disposed or canted state, the tabs tend to be oriented in the direction of the tensioning and guide unit, and the portion that is free of tabs tends to be oriented in the direction of the bottom region of the housing. It is likewise conceivable that the sheet-metal part be formed to essentially have a Y-shaped cross-sectional configuration.

It is advantageous for the tabs to be uniformly distributed over the sheet-metal part and/or circumferentially distributed every 30°, 60°, 90° or 120°. A uniform force characteristic may be achieved in this manner.

When the sheet-metal part is made of a ferrous material and/or spring steel, the securing element may be mass-produced at a low cost and be reliably used for a long period of time.

The present invention also relates to an internal combustion engine having a traction-means drive, as described, and a tensionable traction means.

### BRIEF DESCRIPTION OF THE DRAWINGS

The present invention is explained in greater detail in the following, also with the aid of a drawing, two exemplary embodiments being shown. The figures show:

FIG. 1 a cross section through a tensioner having a housing in which a slide sleeve is seated, the slide sleeve being secured in the housing by a securing element in accordance with a first exemplary embodiment;

FIG. 2 a detail of a cross section through a second specific embodiment;

FIG. 3 a singular representation of the securing element from FIG. 2 in the mounted state on the slide sleeve in a rotated side view;

FIG. 4 the securing element of FIGS. 2 and 3 in a perspective view; and

FIG. 5 another perspective view of the securing element from FIGS. 4, 3 and 2.

### DETAILED DESCRIPTION

The figures are merely schematic and serve exclusively to further the understanding of the present invention. The elements having essentially equivalent functions are denoted by the same reference numerals.

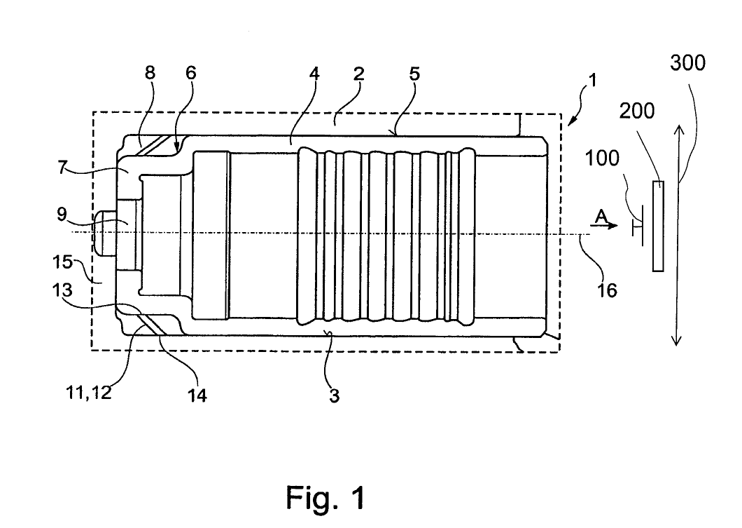

FIG. 1 shows a detail of a traction-means drive having a hydraulic tensioner 1. Not all elements of the traction-means drive are shown; just as not all elements of tensioner 1 are shown.

The tensioner features a housing 2 that is fabricated from an aluminum alloy. A slide sleeve 4 is inserted in the interior of housing 2, which has a cylindrical lateral surface 3 on the inside.

Slide sleeve 4 features a cylindrical outer circumferential surface 5. Cylindrical outer circumferential surface 5 rests against cylindrical lateral surface 3. However, a step 6 is formed at one end 7 of slide sleeve 4, defining a hollow space 8 between housing 2 and slide sleeve 4. Slide sleeve 4 is manufactured of steel. Slide sleeve 4 may be manufactured of hardened or unhardened steel. In the case of hardened steel, a significant advantage is derived from the use of the second exemplary embodiment since it readily eliminates the need for an optional groove in the outer circumferential surface of slide sleeve 4.

In the first exemplary embodiment shown in FIG. 1, an oil feed port 9 is provided in slide sleeve 4 to bring a hydraulic medium, such as oil, into the interior of the slide sleeve and then to extend a piston 100 shown schematically out of slide sleeve 4 in the direction of arrow A. The piston then presses on a tensioning and guide unit 200 shown schematically via a traction means 300 shown schematically, such as a belt or a chain, in order to tension the chain or the belt.

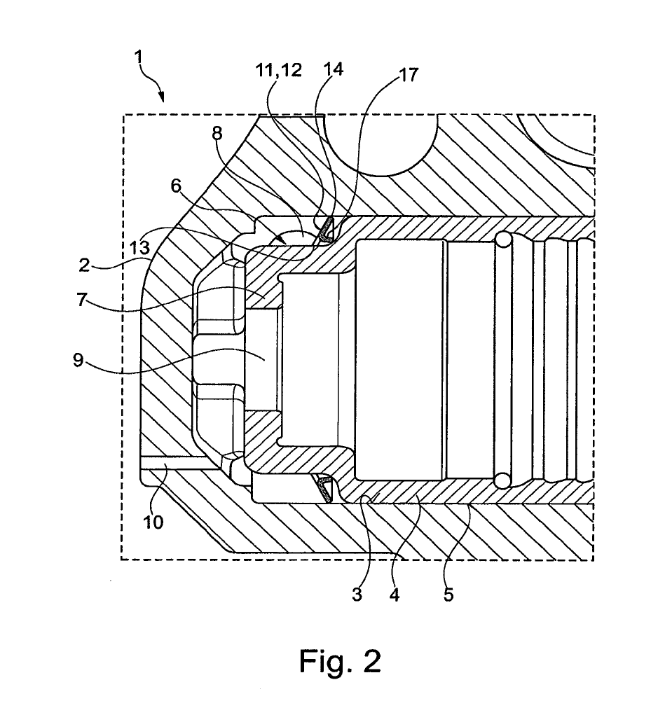

The oil feed port communicates with a supply line 10, which also extends through housing 2, as is readily apparent in FIG. 2.

Referring again to FIG. 1, a securing element 11 is discernible in the interior of cavity 8. Securing element 11 is configured as a conically formed metal disk. Metal disk 12 is made of steel, an inner edge 13 being in contact with outer circumferential surface 5 of slide sleeve 4, and an outer edge 14 being in contact with cylindrical lateral surface 3 of housing 2. Inner edge 13 is configured in greater proximity to a bottom region 15 of housing 2 than is outer edge 14. The contact points between inner edge 13 and cylindrical outer circumferential surface 5, on the one hand, and outer edge 14 and cylindrical lateral surface 3, on the other hand, are configured obliquely to a longitudinal axis 16; it being possible to also refer to this longitudinal axis 16 as axis of symmetry or longitudinal axis of symmetry.

Inner edge 13 is also referred to as an inner rim, just as metal disk 12 is also referred to as a sheet-metal part.

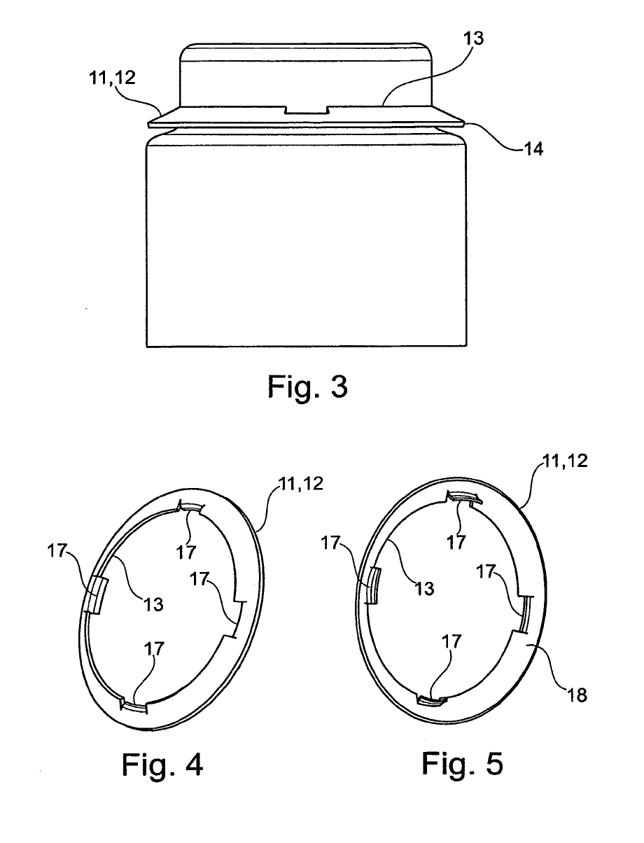

A variant of sheet-metal disk 12 is shown in FIG. 2 through 5. In this context, sheet-metal disk 12 is likewise conical in shape and located concentrically to longitudinal axis 16 on slide sleeve 4. However, unlike the first exemplary embodiment, sheet-metal disk 12 has four tabs 17.

Tabs 17 are configured symmetrically along inner edge 13. They are formed by punched holes, so that the punched elements are still joined to the metal disk, but project by nearly 90° from an inner surface 18 of metal disk 12. Tabs 17 substantially simplify the positioning and mounting of a thus configured metal disk 12.

### LIST OF REFERENCE NUMERALS

1 tensioner
2 housing
3 cylindrical lateral surface
4 slide sleeve
5 cylindrical outer circumferential surface
6 step
7 end
8 cavity
9 oil feed port
10 supply line
11 securing element
12 metal disk
13 inner edge
14 outer edge
15 bottom region of housing
16 longitudinal axis
17 tab
18 inner surface

1-10. (canceled)

11. A traction-mechanism drive comprising:
a hydraulic tensioner including a housing fabricated from a light-metal alloy, a slide sleeve manufactured of steel inserted in the housing and having an axially extendable piston for deflecting a tensioning and guide unit, and a securing element clampingly disposed between the housing and the slide sleeve to prevent the slide sleeve from moving out of the housing.

12. The traction-mechanism drive as recited in claim 11 wherein the securing element is designed as a sheet-metal part or as a spring-wire part.

13. The traction-mechanism drive as recited in claim 12 wherein the spring-wire component has a polygon shape or a wave shape.

14. The traction-mechanism drive as recited in claim 11 wherein the securing element at least partially or even completely embraces the periphery of the slide sleeve.

15. The traction-mechanism drive as recited in claim 11 wherein the securing element is configured in a closed bottom region of the housing that is adjacent to a pressure chamber in the interior of the slide sleeve.

16. The traction-mechanism drive as recited in claim 12 wherein the sheet-metal part has a conical form.

17. The traction-mechanism drive as recited in claim 12 wherein the securing element is the sheet-metal part and, on an inner rim, the sheet-metal part has one or a plurality of tabs, at least one tab resting against the slide sleeve facing in an extended direction of the piston, and at least one portion of the inner rim of the sheet-metal part that is free of tabs, that rests against the slide sleeve, facing counter to the extended direction of the piston.

18. The traction-mechanism drive as recited in claim 17 wherein the tabs are uniformly distributed over the sheet-metal part.

19. The traction-mechanism drive as recited in claim 17 wherein the tabs are circumferentially distributed every 30°, 60°, 90° or 120°.

20. The traction-mechanism drive as recited in claim 12 wherein securing element is the sheet-metal part and is made of a ferrous material or spring steel.

21. The traction-mechanism drive as recited in claim 11 wherein the tensioning and guide unit is a roller or a rail.

22. The traction-mechanism drive as recited in claim 11 wherein the securing element is a securing disk.

23. An internal combustion engine having a traction-mechanism drive as recited in claim 11, and a tensionable traction mechanism.
